(19) United States
(12) Patent Application Publication
(10) Pub. No.: US 2020/0410681 A1
(43) Pub. Date: Dec. 31, 2020

(54) IMAGING SYSTEM AND BIOLOGICAL SUBJECT TRANSFER DEVICE

(71) Applicant: YAMAHA HATSUDOKI KABUSHIKI KAISHA, Iwata-shi, Shizuoka-ken (JP)

(72) Inventor: Masaru SAKAMOTO, Shizuoka (JP)

(73) Assignee: YAMAHA HATSUDOKI KABUSHIKI KAISHA, Iwata-shi, Shizuoka-ken (JP)

(21) Appl. No.: 16/968,649

(22) PCT Filed: Dec. 17, 2018
(86) PCT No.: PCT/JP2018/046336

§ 371 Date: Aug. 10, 2020

(30) Foreign Application Priority Data
Feb. 15, 2018 (JP) 2018-024716

(51) Int. Cl. G06T 7/00

(52) U.S. Cl. CPC G06T 7/0014; G02B 21/02; G06T 2207/30024

(57) ABSTRACT

An image capturing system includes a camera unit capable of performing first image capturing to capture an image of a cell before transfer work is performed and second image capturing to capture the image of the cell after the transfer work; a determination unit configured to make a first determination to determine whether to select the cell based on selection criterion data from the image captured by the first image capturing and a second determination to determine whether to select the cell from the image captured by the second image capturing; a storage unit configured to store the selection criterion data; and a correction unit configured to update the selection criterion data stored in the storage unit to make the first determination and the second determination about the cell identical to each other in a subsequent determination when the first determination and the second determination have different determination results.

### CROSS-REFERENCE TO RELATED APPLICATIONS

This application is a National Stage of International Patent Application No. PCT/JP2018/046336, filed Dec. 17, 2018, which claims priority to Japanese Patent Application No. 2018-024716, filed Feb. 15, 2018, the entire contents of both are incorporated herein by reference.

### BACKGROUND

### Technical Field

The present disclosure relates to an image capturing system including an image capturing device that captures an image of a biological subject such as, for example, cells or cell clusters, and a biological subject transfer device using the image capturing system.

### Background Art

For example, in medical and biological research applications, image capturing for selecting cells or cell clusters (example of a biological subject; sometimes simply referred to as “cell”) may be performed. For example, the work of capturing images of cells accommodated in a transfer-source first container with an image capturing device, selecting desired cells based on the obtained images, and sucking the selected cells with a tip and transferring the cells to a transfer-destination second container may be performed, as described, for example, in WO 2015/087371 A.

Specific examples of cell selection to be performed on the first container side include a method of depending on an operator's manual selection, a method of setting in advance a selection reference value about the size, shape, and the like of the cell, and the like. The former method is a method of depending on skill of an individual by which the operator observes a captured image of the cell and makes a quality determination based on experience of the operator. The latter method is a method of determining a parameter related to the size and shape of a cell by image processing on the captured image of the cell, and automatically making a quality determination based on whether the parameter satisfies the selection reference value.

If the cell is selected as the desired cell on the transfer-source first container side and the cell transferred to the transfer-destination second container is observed again on the second container side as described above, there may be cases where the cell is not the intended cell. That is, if the cell is observed again after the intervention of “work” of cell transfer, the cell actually may not be the intended cell. A similar situation may occur due to the intervention of various types of work. Therefore, there is a problem that work efficiency of inspections, tests, and the like performed on the second container side is reduced.

### SUMMARY

Accordingly, the present disclosure provides an image capturing system that enables accurate selection of the biological subject required by the operator, and a biological subject transfer device using the image capturing system.

An image capturing system according to one aspect of the present disclosure includes an image capturing device capable of performing first image capturing to capture an image of a biological subject before predetermined work is performed and second image capturing to capture the image of the biological subject after the work is performed; and a determination unit configured to make a first determination to determine whether to select the biological subject based on a predetermined selection criterion from the image acquired by the first image capturing, and a second determination to determine whether to select the biological subject from the image acquired by the second image capturing. The image capturing system further includes a storage unit configured to store data regarding the selection criterion; and a correction unit configured to update the data stored in the storage unit to make the first determination and the second determination about the biological subject come close to each other in a subsequent determination when the first determination and the second determination have different determination results.

A biological subject transfer device according to another aspect of the present disclosure includes the above-described image capturing system; and a head device configured to perform transfer work of picking the biological subject selected as the transfer target from the first container accommodating the plurality of biological subjects and transferring the biological subject to the second container as the predetermined work.

### BRIEF DESCRIPTION OF THE DRAWINGS

FIG. 1 is a diagram schematically showing a configuration example of a cell transfer device to which an image capturing system according to an embodiment of the present disclosure is applied;

FIG. 2A is a top view of a dish included in a selection container used in the cell transfer device, and FIG. 2B is a cross-sectional view taken along line IIB-IIB of FIG. 2A;

FIG. 3A is a perspective view of a microplate used in the cell transfer device, and FIG. 3B is a longitudinal cross-sectional view of FIG. 3A;

FIG. 4 is a diagram for describing a concept of feedback of cell selection in the present embodiment;

FIG. 5 is a diagram showing a feedback example of cell selection in a first embodiment in which work is a cell transfer;

FIGS. 6A and 6B are diagrams showing a feedback example of cell selection in a second embodiment in which work is a cell selection by an operator;

FIGS. 7A and 7B are diagrams showing a feedback example of cell selection in a third embodiment in which work is a change in an image capturing condition;

FIGS. 8A and 8B are diagrams showing a feedback example of cell selection in a modification of the third embodiment in which work is a change in an image capturing condition;

FIGS. 9A to 9D are diagrams showing a feedback example of cell selection in a fourth embodiment in which work is dispensing of a reagent;

FIG. 10 is a diagram showing a feedback example of cell selection in a fifth embodiment in which work is work of waiting for an elapse of a test time;

FIG. 11 is a block diagram of the cell transfer device according to the embodiment of the present disclosure; and

FIG. 12 is a flowchart of a cell transfer operation using the image capturing system.

### DETAILED DESCRIPTION

Embodiments of the present disclosure will be described in detail below with reference to the drawings. An image capturing system according to the present disclosure can capture images of a wide variety of biological subjects. In the present disclosure, as the biological subject to be captured, a cell of biological origin can be typically illustrated. Examples of the cell of biological origin here include a single cell (cell) such as a blood cell and single cell, tissue fragment such as Histoculture and CTOS, cell aggregation cluster such as spheroids and organoids, individuals such as zebrafish, nematodes, fertilized eggs, and 2D or 3D colony. In addition, tissues, microorganisms, small species, and the like can be illustrated as the biological subject. The embodiment described below show an example in which the biological subject is cells or a cell aggregation cluster formed by aggregating several to several hundred thousand cells (hereinafter, collectively referred to simply as “cell C”).

[Overall Structure of Cell Transfer Device]

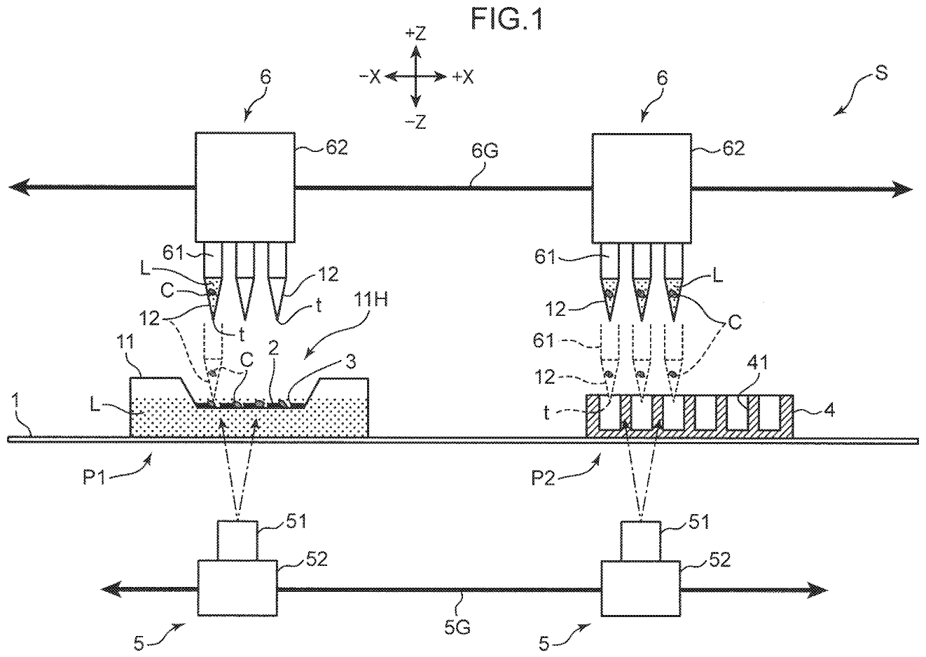

FIG. 1 is a diagram schematically showing an overall configuration of a cell transfer device S to which an image capturing system according to an embodiment of the present disclosure is applied. Here, the cell transfer device S that transfers a cell C between two containers (dish 2 and microplate 4) is illustrated.

The cell transfer device S includes a translucent base 1 having an upper surface, which is a horizontal mounting surface, a camera unit 5 (image capturing device) placed below the base 1, and a head unit 6 (head device) placed above the base 1. A selection container 11 including the dish 2 (first container) is mounted at a first mounting position P1 of the base 1, and the microplate 4 (second container) is mounted at a second mounting position P2. The head unit 6 includes a plurality of heads 61 to which tips 12 that each suck and discharge the cell C are attached, the heads 61 capable of moving in a Z direction (up-and-down direction). The camera unit 5 and the head unit 6 are movable in the X direction (horizontal direction) and the direction perpendicular to the plane of FIG. 1 (Y direction). The dish 2 and the microplate 4 are mounted on an upper surface of the base 1 within a movable range of the head unit 6.

Roughly, the cell transfer device S is a device in which each of the plurality of tips 12 sucks the cell C individually from the dish 2 of the selection container 11 holding a large number of cells C, and transfers the cell C to the microplate 4, and the plurality of tips 12 simultaneously discharge the cells C to wells 41 of the microplate 4. Before the suction of the cells C, the cells C held in the dish 2 are captured by the camera unit 5 (first image capturing), and selection work of selecting good quality cells C to be transferred to the microplate 4 is performed. After the transfer of the cells C, the cells C accommodated in the microplate 4 are captured (second image capturing) by the camera unit 5, and the cells C are observed for the purpose of verifying the validity of the selection work.

Each part of the cell transfer device S will be described below. The base 1 is a rectangular flat plate having predetermined rigidity, and part or all of which is formed of a translucent material. The preferred base 1 is a glass plate. The base 1 is formed of a translucent material such as a glass plate, thereby allowing the camera unit 5 placed below the base 1 to capture the selection container 11, the dish 2, and the microplate 4 placed on an upper surface of the base 1 through the base 1.

The selection container 11 is a container that is a transfer source of the cells C, stores a culture medium L, and holds the dish 2 for cell selection in a state of being immersed in the culture medium L. The dish 2 is a plate that holds the cells C, and has a plurality of holding recesses 3 that can individually accommodate and hold the cells C on an upper surface. The culture medium L is not particularly limited as long as the culture medium L does not deteriorate the properties of the cells C, and can be appropriately selected depending on the type of cell C.

The selection container 11 includes a rectangular upper opening 11H on the upper surface side. The upper opening 11H is an opening for injecting the cells C and picking up the selected cells C. The dish 2 is placed below the upper opening 11H. The selection container 11 and the dish 2 made of a translucent resin material or glass is used. This is to allow the camera unit 5 placed below the selection container 11 to observe the cells C supported in the dish 2.

A plurality of cells C dispersed in a cell culture solution is injected into the selection container 11 from a dispensing tip (not shown). The dispensing tip sucks the cell culture solution together with the cells C from a container that stores the cell culture solution containing the large amount of cells C, and holds the cell culture solution in the dispensing tip. Thereafter, the dispensing tip is moved to an upper air position of the selection container 11 to access the upper surface of the dish 2 through the upper opening 11H. Then, with a tip opening of the dispensing tip immersed in the culture medium L of the selection container 11, the cells C held in the dispensing tip are discharged onto the dish 2 together with the cell culture solution.

The microplate 4 is a container serving as a transfer destination for the cells C, and includes a plurality of wells 41 in which the cells C are discharged. The wells 41 are each a bottomed hole opened on an upper surface of the microplate 4. One well 41 accommodates a required number of (usually one) cells C together with the culture medium L. The microplate 4 made of a translucent resin material or glass is used. This is to allow the camera unit 5 placed below the microplate 4 to observe the cells C supported in the well 41.

The camera unit 5 captures an image of the cells C held in the selection container 11 or the microplate 4 from the lower surface side thereof, and includes a lens unit 51 and a camera body 52. The lens unit 51 is an object lens used in an optical microscope, and includes a lens group that forms a light image with a predetermined magnification and a lens barrel that accommodates the lens group. The camera body 52 includes an image capturing element such as a CCD image sensor. The lens unit 51 forms a light image of an image capturing target on a light receiving surface of the image capturing element. The camera unit 5 is movable in the X and Y directions below the base 1 along a guide rail 5G extending in the left-right direction parallel to the base 1. In addition, the lens unit 51 is movable in the Z direction for a focusing operation.

The head unit 6 is provided for picking the cell C selected as a transfer target from the dish 2 serving as the first container that accommodates a plurality of cells C, and performing transfer work (predetermined work) of transferring the cell C to the microplate 4 serving as the second container. The head unit 6 includes a plurality of heads 61 and a head body 62 to which the heads 61 are assembled. At the tip of each head 61, the tip 12 that sucks (pickup) and discharges the cells C is attached. The head body 6:2 holds the heads 61 so as to be raised and lowered in the +Z and −Z directions, and is movable in the +X and −X directions along a guide rail 6G. Note that the head body 62 is also movable in the Y direction.

[Details of Dish and Microplate]

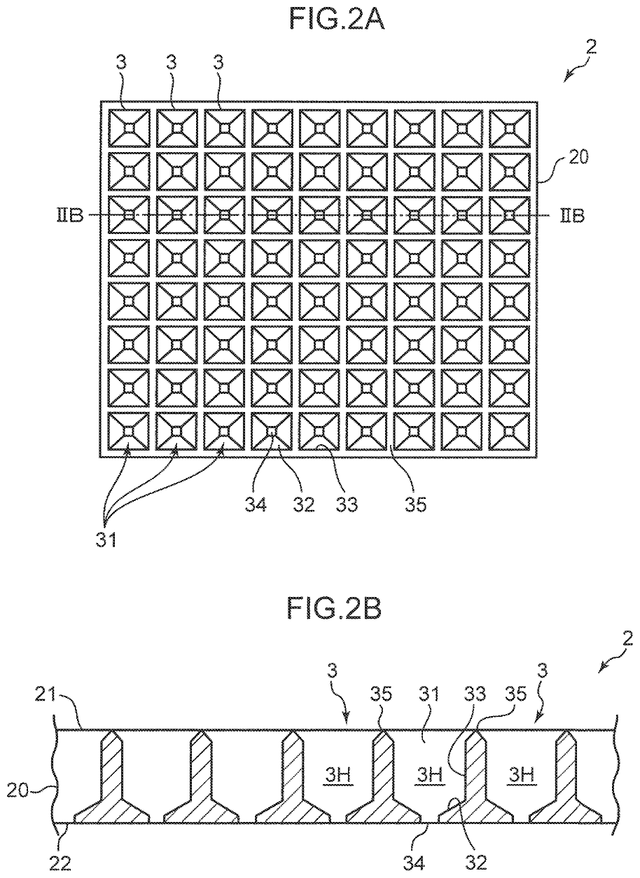

First, detailed structure of the dish 2, which is a transfer-source container, will be described. FIG. 2A is a top view of the dish 2, and FIG. 2B is a cross-sectional view taken along line IIB-IIB of FIG. 2A. The dish 2 includes a dish body 20 and a plurality of holding recesses 3 formed in the dish body 20. The dish body 20 includes a flat plate-shaped member having a predetermined thickness and includes an upper surface 21 and a lower surface 22. Each holding recess 3 includes an opening portion 31 serving as an opening that receives the cell C on the upper surface 21 side. The dish 2 is immersed in the culture medium L in the selection container 11. In detail, the dish 2 is held in the selection container 11 with a space between the lower surface 22 and a bottom plate of the selection container 11 while the upper surface 21 of the dish body 20 is immersed in the culture medium L in the selection container 11 (see FIG. 1).

Each of the holding recesses 3 includes an opening portion 31, a bottom portion 32, a cylindrical wall surface 33, a hole portion 34, and a boundary portion 35. The present embodiment shows an example in which the holding recesses 3 that are square in top view are arranged in a matrix. As shown in FIG. 2B, the plurality of holding recesses 3 is arranged in a matrix at a predetermined recess arrangement pitch.

The opening portion 31 is a square opening provided on the upper surface 21, and has a size that allows entrance of a tip opening portion t of the tip 12 for selection. The bottom portion 32 is positioned inside the dish body 20 and near the lower surface 2:2. The bottom portion 32 is an inclined surface that gently inclines downward toward the center (center of the square). The cylindrical wall surface 33 is a wall surface extending vertically downward from the opening portion 31 toward the bottom portion 32. The hole portion 34 is a through hole vertically, penetrating between the center of the bottom portion 32 and the lower surface 22. The boundary portion 35 is a portion that is positioned on the upper surface 21 and serves as an opening edge of each holding recess 3, and is a ridge line that partitions the holding recesses 3 from each other.

The bottom portion 32 and the cylindrical wall surface 33 of each holding recess 3 define an accommodation space 311 that accommodates the cell C. It is generally intended that one cell C is accommodated in the accommodation space 3H. The hole portion 34 is provided to allow a small cell or impurities having a size other than a desired size to escape from the accommodation space 3H. Therefore, the size of the hole portion 34 is selected such that the cell C having the desired size cannot pass through but a small cell and impurities other than the desired size can pass through. Accordingly, the cell C to be selected is trapped in the holding recess 3, while impurities and the like fall from the hole portion 34 to the bottom plate of the selection container 11.

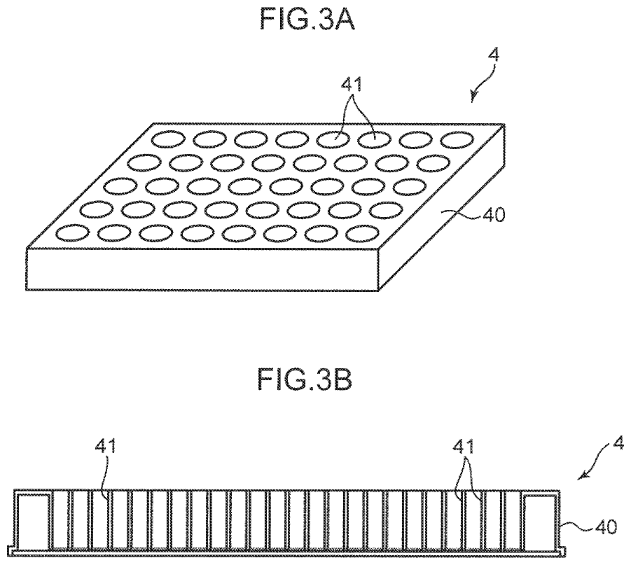

Next, the microplate 4, which is a transfer-destination container, will be described. FIG. 3A is a perspective view of the microplate 4, and FIG. 3B is a longitudinal cross-sectional view of the microplate 4. The microplate 4 includes a plate body 40 and a plurality of wells 41 arranged in a matrix in the plate body 40. Since the tip opening portion t of the tip 12 enters the well 41 when the cell C is discharged, each well 41 has an opening diameter that allows the entry of the tip 12 with a margin.

There is a reference size for commercially available microplates. The reference microplate has a predetermined longitudinal×lateral size (longitudinal 85.48 mm×lateral 126 mm) and includes a predetermined number of wells. The general number of wells is 24×16 (384 wells), and the wells are arranged in a matrix at a predetermined pitch. FIG. 3B is a cross-sectional view of the microplate 4 with 384 wells. As shown in the FIG. 3B, 24 wells 41 are arranged at an equal well pitch in the longitudinal direction of the microplate 4 (16 wells in the lateral direction).

[Outline of Cell Selection Work]

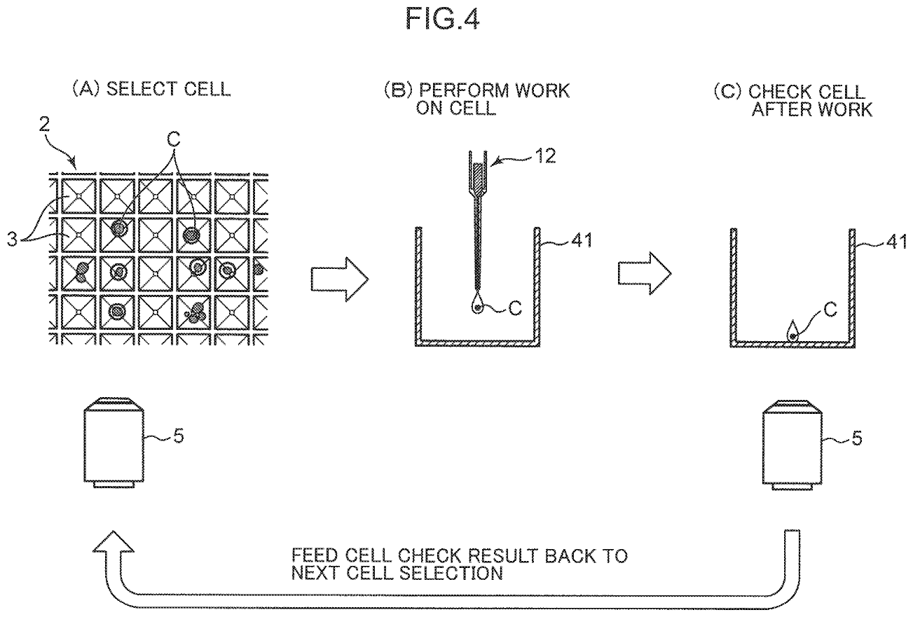

FIG. 4 is a diagram for describing the outline of the cell selection work (steps (A) to (C)) in the present embodiment. First, in step (A), the camera unit 5 captures an image of the dish 2 (first image capturing), and acquires a first image of the cells C supported in the holding recesses 3 of the dish 2. In this first image, the cells C before predetermined work is performed, in the present embodiment, the cells C before the transfer work of the cell C is performed are captured. Then, based on a predetermined selection criterion from the first image, a first determination is made to determine which of the cells C captured in the image is to be selected as the transfer target.

The selection criterion is, for example, data of a manual selection criterion that is inherently determined by each operator who performs the cell selection work based on experience or the like, or data of a selection criterion determined in advance regarding the size, shape, or the like of the cell. When relying on the latter, a feature amount of the cells C captured in the first image is obtained by image processing. In this case, the first determination is a determination as to whether the obtained feature amount satisfies the selection criterion data.

In step (B), work on the cell C is performed. In the present embodiment, the work is work of individually picking the cell C selected as the transfer target in the first determination from the holding recess 3 of the dish 2 by using the tip 12, and transferring the cell C to one well 41 of the microplate 4. Note that the work on the cell C is not limited to the above transfer work. For example, in addition to the case where the work is the cell selection itself by the operator (second embodiment described later), work of changing an image capturing condition of the cell C by the camera unit 5 (third embodiment), work of dispensing a reagent for the cell C (fourth embodiment), work of waiting for an elapse of a test time for the cell C (fifth embodiment), and the like can be illustrated.

In step (C), the camera unit 5 captures an image of the microplate 4 to which the cell C has been transferred by the transfer work in step (B) (second image capturing), and acquires a second image of the cell C held in the well 41. In the second image, the cell C that has undergone the predetermined work is captured. In the second image, a second determination is made to check validity of each cell C transferred to the well 41. The second determination is determination as to which cell C is to be selected from among the cells C captured in the image, for example, as a target of the work on the cell C in the next stage, for example, work of adding a reagent, inspection, observation, or the like.

In this way, the selection of the cell C is determined in the two stages of the first determination and the second determination for the following reason. First, it can be cited that the work performed between the first and second determinations, that is, the transfer work may cause deformation, deterioration, collapse, or the like of the cell C. For example, an easily deformable cell C may be deformed when sucked by the tip 12, or what looks like one cell C may be decomposed into a plurality of cells.

Next, it can be cited that an erroneous determination is made in the first determination. The first determination is made based on the image of the cell C supported in the holding recess 3. That is, the first determination is made based on the feature amount such as the shape, color tone, or the like of the cell C appearing in the first image acquired through a bottom surface of the selection container 11 and the bottom portion 32 of the holding recess 3. Therefore, an error factor may intervene in a transmitted light image of the cell C, and also, only the lower half surface of the cell C can be observed. Therefore, if the cell C is observed again based on the second image acquired after the work, the cell C may actually be found to be defective. In some cases, it may be possible to recognize that the cell C is defective only after the second image capturing is performed under an image capturing condition different from the first image capturing. In addition, the cell C may be found to be defective by acquiring the second image after work of applying some treatment to the cell C or after an aging period. It is requested to make the second determination for such a reason.

If a determination result different from a result of the first determination is obtained in the second determination of step (C), the discrepancy is fed back to the first determination in the next procedure (A). Specifically, if the cell C of discrepancy (error) that has been determined differently between the first and second determinations is generated, the feature amount of the cell C (error) is obtained, for example, from the second image. Then, in the subsequent determination processing, selection criterion data on which the first determination relies is updated with reference to the feature amount of the cell C (error) such that the first determination and the second determination on the cell C (error) come close to each other, that is, they become identical to each other. By repeating such an update (learning), only the cell C determined to be “selected” in the second determination will be selected in the first determination as well, and the first determination and the second determination are gradually homogenized. In a short time, the cell C that is truly necessary can be selected only by the first determination, and the second determination can be omitted, enabling improvement in the work efficiency. Examples of feedback for cell selection are specifically shown below for each work type.

### First Embodiment

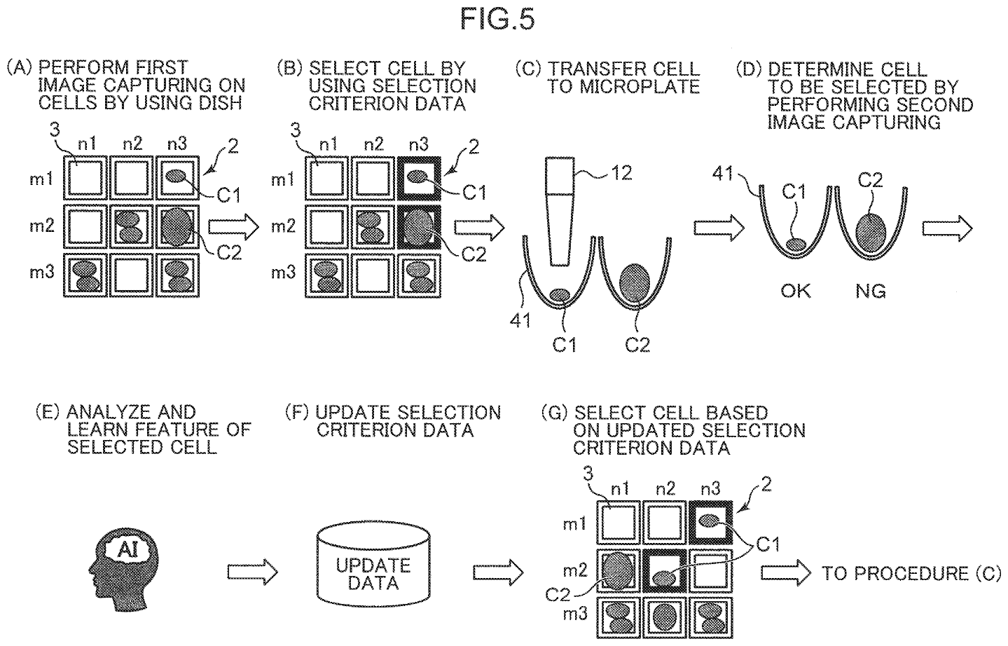

FIG. 5 is a diagram schematically showing procedures (A) to (G) of feedback of cell selection in a first embodiment in which the work is the cell transfer outlined above. In the first procedure (A), the first image capturing is performed in which the camera unit 5 captures an image of the dish 2. By this first image capturing, the first image of the cells C supported in the holding recesses 3 of the dish 2 is acquired. The lens unit 51 of the camera unit 5 has an angle of view that can simultaneously capture an image of a plurality of cells C. The procedure (A) shows an example in which an image of the holding recesses 3 of a 3×3 (m1 to m3×n1 to n3) matrix is captured by one image capturing operation. The example here shows a state in which one cell C is supported in each of the holding recesses 3 of m1n3 and m2n3, two cells C are supported in each of the holding recesses 3 of m2n2, m3n1, and m3n3, and no cell C is supported in other holding recesses 3.

In the subsequent procedure (B), based on the first image acquired in the procedure (A), the first determination is made about which cell C is to be transferred. As described above, the selection criterion data is used for the first determination. The feature amount of the cell C held in each holding recess 3 is extracted by analyzing the first image. Examples of the feature amount include an amount of cell C obtained from the number, area, estimated volume, and the like of the cell C, color and appearance of the cell C, light intensity when the cell C is fluorescent, and the like. Analysis results of the cell C in each holding recess 3 are digitized. The selection criterion data is, for example, a parameter that defines the range of cell C to be selected. In the first determination, it is determined whether the feature amount of each cell C belongs to the range of the parameter, and the cell C that belongs to the range is selected as the transfer target. Here, an example is shown in which the cell C1 of m1n3 and the cell C2 of m2n3 are selected as the transfer target (highlighted by black frames in FIG. 5. The same applies hereinafter.).

In the next procedure (C), as predetermined work, the cells C1 and C2 selected as the transfer target are transferred to each well 41 of the microplate 4 by the tip 12. When the transfer is completed, as shown in the procedure (D), the second image capturing is performed to capture the image of the microplate 4 holding the transferred cells C1 and C2 by the camera unit 5. Then, based on the second image obtained by the second image capturing, the second determination is made as to whether to select the cells C1 and C2 for subsequent work. The second determination may be made by either of manual selection by the operator or automatic selection using the feature amount. Here, an example is shown in which the cell C1 is selected (OK) and the cell C2 is not selected (NG) in the second determination. Note that as the feature amount, information such as the number, amount, color, appearance, light intensity, and the like of the cell C accommodated in the well 41 can be used. In particular, the number of cells C is information that can be most easily identified, including the case where the number is 0, and thus it is preferable that at least the number of cells C be included in the feature amount.

In the subsequent procedure (E), the feature amount of the cell C1 selected in the second determination or the cell C2 not selected in the second determination is extracted based on the second image. Then, as shown in the procedure (F), the extracted feature amount is fed hack (updated) to the selection criterion data to be used in the first determination. In this way, in the first determination based on the previous selection criterion data, the cell C2 has been determined to be “selected”, but in the subsequent first determination, the cell C2 is determined to be “not selected”.

The procedure (G) shows an example of cell selection after the feedback. That is, in the first determination after the feedback, the cell C1 or a cell C in a similar category is selected, but the cell C2 or a cell C in a similar category is not selected. Thereafter, a transition is made to the procedure (C), the selected cell C1 is transferred to each well 41, and the second determination of the procedure (D) is made similarly. In this case, since only the cell C1 is transferred to the well 41, the cell C1 will be selected in the second determination. That is, in the selection of the cell C, no discrepancy occurs between the first determination and the second determination.

### Second Embodiment

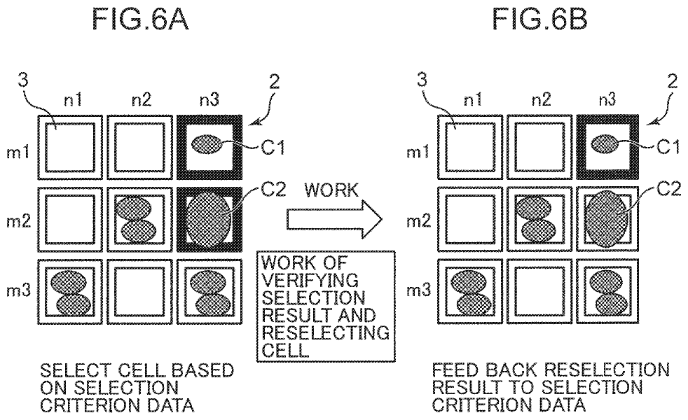

FIGS. 6A and 6B are diagrams showing a feedback example of cell selection in a second embodiment in which work is a cell selection by an operator. Here, an example is shown in which the operator manually reselects validity of a cell C selected in the first determination based on the selection criterion data described above in the dish 2. That is, before the transfer work of the cell C described in the first embodiment, the operator performs the work of the manual selection operation that also serves as the second determination on the cell C automatically selected based on the selection criterion data. Then, the result of the cell C by the manual selection operation is fed back to the first determination.

FIG. 6A shows a result of the first determination made on the first image acquired by the first image capturing based on the selection criterion data at a certain time point. Here, an example is shown in which the cell C1 of m1n3 and the cell C2 of m2n3 are selected in the first determination. The operator makes the second determination (reselection operation) as to whether these cells C1 and C2 are appropriate as the selection target by the manual selection operation. Note that since the image of the dish 2 is referred to in the second determination, the first image acquired previously is used. That is, in the present embodiment, the second image is not newly acquired, and the first image is used as the second image. The present disclosure also includes such an embodiment.

FIG. 6B is a diagram showing a result of the second determination by the operator. Here, an example is shown in which the cell C1 is selected but the cell C2 is not selected in the second determination. Thereafter, in a similar manner to the procedures (E) and (F) of the first embodiment, the feature amount of the cell C1 or the cell C2 is extracted, and the extracted feature amount is fed back to the selection criterion data used for the first determination. With this operation, in the subsequent first determination, it is determined that the cell C2 is “not selected”.

### Third Embodiment

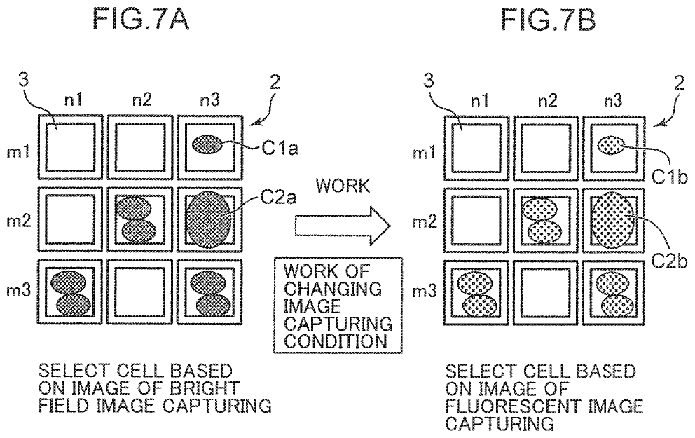

FIGS. 7A and 7B are diagrams showing a feedback example of cell selection in a third embodiment in which work is a change in an image capturing condition. As described above, in the embodiments of the present disclosure, the first determination and the second determination are made based on a two-dimensional image of a cell C. In this case, by changing the image capturing condition, it may be possible to clearly make a quality determination of the cell C that is difficult to make with a captured image under the same image capturing condition. In view of this point, in the third embodiment, first image capturing is performed to acquire a first image under a predetermined image capturing condition and the first determination is made, and the image capturing condition is changed to acquire a second image in subsequent second image capturing and the second determination is made. That is, work in the third embodiment is work of changing the image capturing condition in the first image capturing. Then, a selection result of the cell C by the second determination is fed back to the first determination.

FIG. 7A is the first image of the cells C captured by the first image capturing, showing an image obtained by bright field image capturing. That is, FIG. 7A is an image acquired by a camera unit 5 under the condition of “bright field image capturing”. In the first image, the first determination is made based on the selection criterion data at that time. Thereafter, the work of changing the image capturing condition is performed. Examples of changeable image capturing conditions include an angle of view, image capturing angle, magnification, light exposure, nature of illumination light, amount of light, lens type, and the like. Needless to say, a change in the camera unit 5 used is included.

FIG. 7B is the second image of the cells C acquired by the second image capturing after the image capturing condition is changed, and in this case, shows an image obtained by fluorescent image capturing. That is, FIG. 7B is an image acquired by the camera unit 5 under the condition of “fluorescent image capturing”. The fluorescent image capturing is performed, for example, by adding a fluorescent agent or using fluorescent illumination. In the second image, for example, the operator makes the second determination as to which cell C is to be selected by a manual selection operation. A selection result of the cell C by the second determination is fed back to the first determination.

When the cell C1a of m1n3 and the cell C2a of m2n3 observed in the first image of bright field image capturing are observed in the second image of fluorescent image capturing, the cells C1a and C2a are observed as cells C1b and C2b having different light images, respectively. Here, a defect of the cell C overlooked by the bright field image capturing may be observed by the fluorescent image capturing. That is, if based on an image acquired by changing a method of viewing the cell C, more accurate selection determination can be made in some cases. The defect may actually appear as a feature amount in the first image of bright field image capturing. Therefore, by feeding back the result of the second determination based on the second image of fluorescent image capturing to the selection criterion data, more accurate first determination can be made.

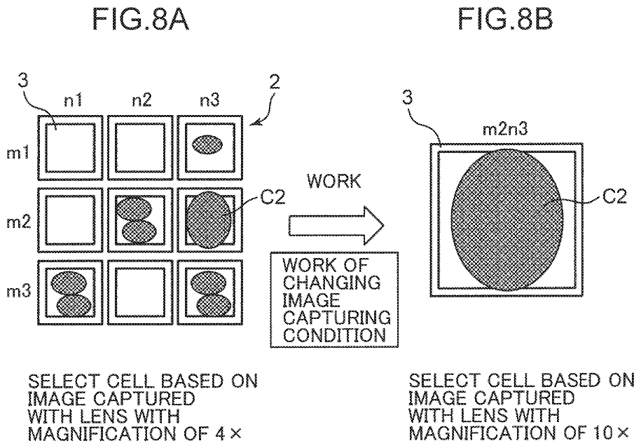

FIGS. 8A and 8B are diagrams showing a modification of the third embodiment. Work of changing the image capturing condition in this modification is work of changing image capturing magnification of a lens unit 51 of the camera unit 5. FIG. 8A is the first image of the cells C captured by the first image capturing, and shows, for example, an image captured with a lens with a magnification of 4×. Meanwhile, FIG. 8B is the second image of the cell C acquired by the second image capturing after the image capturing magnification is changed, and shows, for example, an image of the cell C2 of m2n3 captured with a lens with a magnification of 10×.

In some cases, the determination of necessity of selection (second determination) performed on the cell C2 based on the enlarged second image of FIG. 8B may allow more accurate determination than the determination of necessity of selection (first determination) performed on the cell C2 based on the first image of FIG. 8A. For example, a defect that is unable to be identified in the 4× image may be observed in the 10× image. Therefore, by feeding back the result of the second determination based on the second image with the higher magnification to the selection criterion data, the first determination can be made more accurately.

### Fourth Embodiment

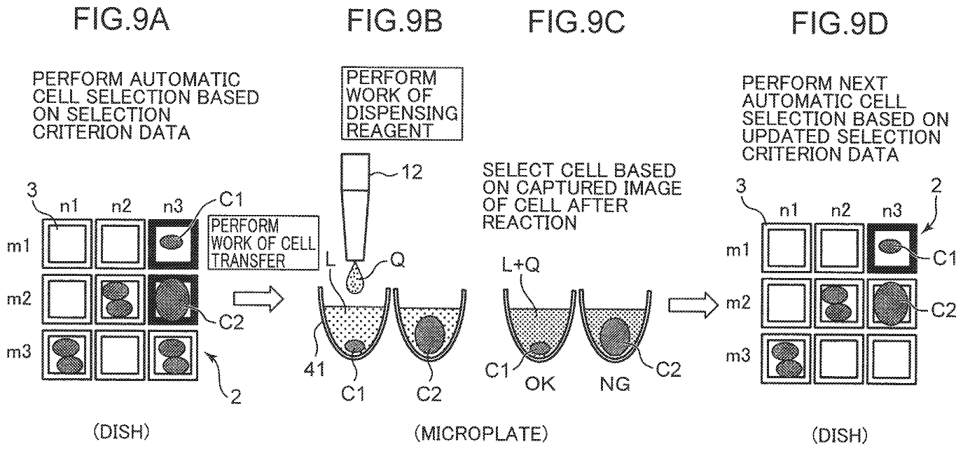

FIGS. 9A to 9D are diagrams showing a feedback example of cell selection in a fourth embodiment in which work is dispensing of a reagent. A selected cell C is subjected to a sensitivity test to a reactive test substance such as a reagent or a growth agent in many cases. It is possible that a cell C selected as a good quality cell C suitable for the test is a cell C unsuitable for the sensitivity test. In view of this point, in the fourth embodiment, after the first determination, work of adding a reactive test substance to the selected cell C is performed. The second image capturing is performed on the cell C after the work to acquire the second image, and a quality determination (second determination) is made on the cell C. Then, a selection result of the cell C by the second determination is fed back to the first determination.

FIG. 9A shows a result of the first determination made on the first image captured by the first image capturing based on the selection criterion data at a certain time. Here, an example is shown in which the cell C1 of m1n3 and the cell C2 of m2n3 are selected in the first determination. As first work, work of transferring the selected cells C1 and C2 to respective wells 41 of a microplate 4 by a tip 12 is performed. The work up to this point is the same as in the first embodiment described above.

Subsequently, as shown in FIG. 9B, as second work, work of dispensing a reagent Q by using the tip 12 is performed on each well 41 accommodating the transferred cell C1 or C2 and the culture medium L. After a predetermined time has elapsed after the dispensing of the reagent Q is finished, as shown in FIG. 9C, the second image capturing is performed by the camera unit 5 that captures the image of the microplate 4 holding the transferred cells C1 and C2. With this operation, the image of the cells C1 and C2 after the reaction to the reagent s acquired as the second image. In this second image, for example, the operator makes the second determination to select whether the cells C1 and C2 are appropriate as targets for the sensitivity test by a manual selection operation. Here, an example is shown in which the cell C1 is selected (OK) and the cell C2 is not selected (NG) in the second determination.

Then, as shown in FIG. 9D, the selection result of the cells C1 and C2 by the second determination is fed back to the first determination. That is, the feature amount of the cell C1 or C2 is extracted, and the extracted feature amount is fed hack (updated) to the selection criterion data used for the first determination. With this operation, in the subsequent first determination, it is determined that the cell (12 is “not selected”. Therefore, the cell C is selected before the addition work of the reagent Q so as to follow the selection result of the cell C after the addition work of the reagent Q.

### Fifth Embodiment

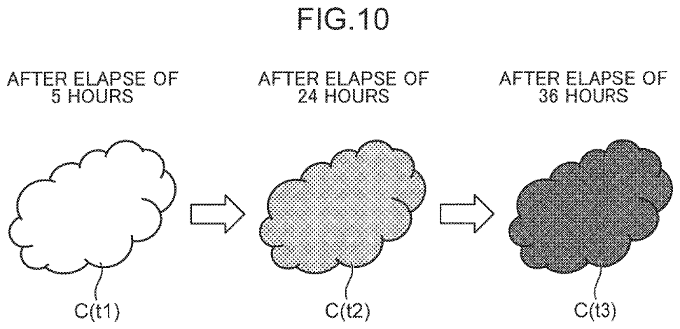

FIG. 10 is a diagram showing a feedback example of cell selection in a fifth embodiment in which work is work of waiting for an elapse of a test time. Even if a cell C is left in a culture medium L without particularly adding a reagent Q or the like, the shape and properties of the cell C may change. For example, growth, death, division, discoloration, and the like of the cell C can be illustrated. FIG. 10 shows an example in which the color of the cell C changes as time elapses, and simply illustrates the state of cells C (t1), C (t2), and C (t3) after 5 hours, 24 hours, and 36 hours elapse, respectively. Therefore, waiting for an elapse of a predetermined test time for the cell C can also be the “work” for the cell C.

The fifth embodiment can be implemented, for example, by replacing the reagent dispensing work in FIG. 9B of the fourth embodiment with the work of waiting for an elapse of a test time. In this case, the second image capturing and cell selection (second determination) of FIG. 9C are performed after the elapse of a predetermined test time after the cells C1 and C2 are transferred to the wells 41. Then, a result of the second determination is fed back to the first determination.

[Electric Configuration of Cell Transfer Device]

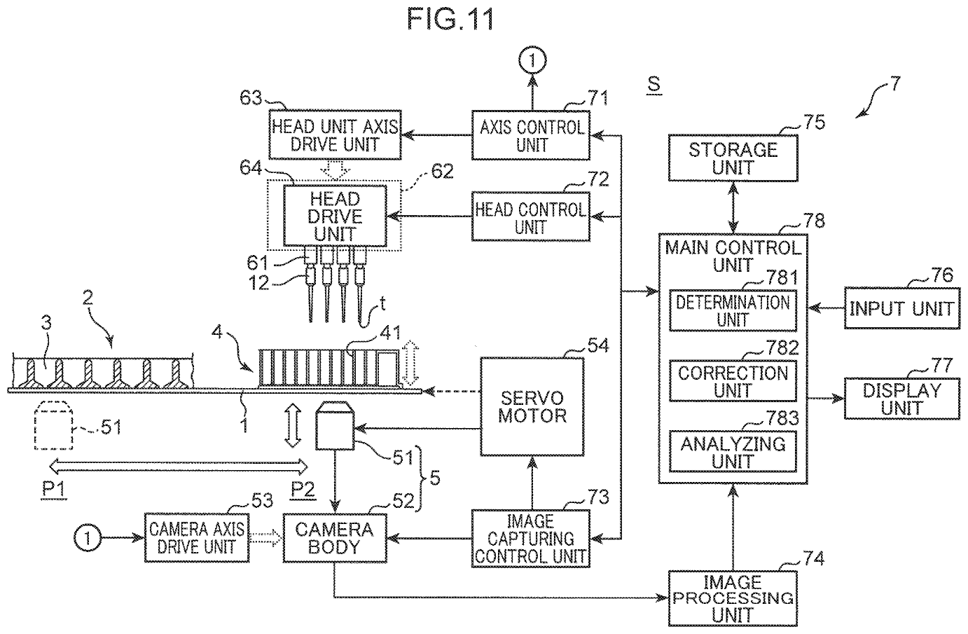

FIG. 11 is a block diagram showing an electrical configuration of the cell transfer device S. The cell transfer device S includes a control unit 7 that controls movement of the head unit 6, raising and lowering of the heads 61 and the tips 12, suction and discharge operations of the cell C, movement and image capturing operations of the camera unit 5, and the like. In addition, the cell transfer device S includes a camera axis drive unit 53 serving as a mechanism for horizontally moving the camera unit 5, a servo motor 54 serving as a driving source for moving the lens unit 51 up and down, a head unit axis drive unit 63 serving as a mechanism for horizontally moving the head unit 6, and a head drive unit 64 serving as a mechanism for raising and lowering the head 61 and a mechanism for performing suction and discharge operations.

The camera axis drive unit 53 includes a drive motor that horizontally moves the camera unit 5 along the guide rail 5G (FIG. 1). The camera axis drive unit 53 moves the camera unit 5 between the first mounting position P1 directly under the dish 2 and the second mounting position P2 directly under the microplate 4.

The servo motor 54 rotates forward or backward to move the lens unit 51 in an up-and-down direction with a predetermined resolution via a power transmission mechanism (not shown). By this movement, the focus position of the lens unit 51 is adjusted to the cells C accommodated in the holding recesses 3 of the dish 2 or the wells 41 of the microplate 4. Note that as shown by the dotted line in FIG. 11, instead of the lens unit 51, the selection container 11 or the microplate 4 itself or the base 1 that is a stage on which the selection container 11 and the microplate 4 are mounted may be moved up and down by the servo motor 54.

The head unit axis drive unit 63 includes a drive motor that moves the head unit 6 (head body 62) along the guide rail 6G. The head drive unit 64 includes a motor serving as a power source that raises and lowers the head 61 with respect to the head body 62, and a mechanism serving as a power source that generates suction force and discharge force at the tip opening portion t of the tip 12.

The control unit 7 includes a microcomputer or the like, and functions to include an axis control unit 71, a head control unit 72, an image capturing control unit 73, an image processing unit 74, a storage unit 75, and a main control unit 78 by executing a predetermined program. Furthermore, an input unit 76 that inputs various information items to the control unit 7 and a display unit 77 that displays various information items are included. The input unit 76 functions as a terminal that receives input regarding the cell C selection operation from the operator. The display unit 77 functions as a monitor that displays the first image, the second image, and the like captured by the camera unit 5.

The axis control unit 71 controls the operation of the head unit axis drive unit 63. That is, the axis control unit 71 controls the head unit axis drive unit 63 to move the head unit 6 to a predetermined target position in the horizontal direction. Movement of the head 61 (tip 12) between the selection container 11 and the microplate 4, positioning in the vertically upper position with respect to the holding recess 3 of the dish 2, and positioning in the vertically upper position with respect to the well 41 of the microplate 4 serving as a discharge target are implemented by the control of the head unit axis drive unit 63 by the axis control unit 71.

The head control unit 72 raises and lowers the head 61 to be controlled toward a predetermined target position by controlling the head drive unit 64. Also, the head control unit 72 generates suction force or discharge force at the tip opening portion t of the tip 12 at predetermined timing by controlling the suction mechanism corresponding to the head 61 to be controlled.

The image capturing control unit 73 controls the operation of moving the camera unit 5 along the guide rail 5G by controlling the camera axis drive unit 53. Also, the image capturing control unit 73 controls the image capturing operation of the dish 2 or the microplate 4 by the camera unit 5, such as, for example, the exposure amount and shutter timing. Furthermore, the image capturing control unit 73 gives control pulses for moving the lens unit 51 in an up-and-down direction at a predetermined pitch (for example, tens of μm pitch) to the servo motor 54 for the focusing operation.

The image processing unit 74 performs image processing such as edge detection processing and pattern recognition processing with feature amount extraction on image data acquired by the camera body 52. Based on the image of the dish 2 after the cells C are dispensed, the image processing unit 74 performs processing of recognizing the presence and number of the cells C on the holding recesses 3 of the dish 2 on the image, processing of acquiring the XY coordinates of each cell C, processing of acquiring condition information such as an outer contour, size such as an area and volume, shape, color tone, and the like of individual cell C. Similarly, based on the image of the wells 41 to which the cells C are transferred, the image processing unit 74 performs processing of recognizing the number, an amount such as total area and total volume, fluorescence intensity, and the like of the cells C accommodated in the wells 41.

The storage unit 75 stores various setting values, data, programs and the like in the cell transfer device S. In addition, the storage unit 75 stores data regarding the selection criterion of the cell C to be used for the first determination. As described above, the selection criterion data is updated according to the cell selection result of the second determination made after the predetermined work is performed on the cell C.

The main control unit 78 comprehensively controls the operations of the camera unit 5 and the head unit 6. The main control unit 78 controls the camera unit 5 and the head unit 6 through the axis control unit 71, the head control unit 72, and the image capturing control unit 73 to capture the image of the dish 2 on which the cells C are scattered at the first mounting position P1 (FIG. 1) where the selection container 11 is mounted, perform picking to cause the tip 12 attached to the head 61 to suck the cells C selected as the transfer target, and transfer the cells C to the microplate 4. In such comprehensive control, the main control unit 78 makes the first determination for automatically selecting the cell C to be transferred from the dish 2, and the second determination for determining whether to select the cell C transferred to the microplate 4.

The main control unit 78 functionally includes a determination unit 781, a correction unit 782, and an analyzing unit 783 for the first and second determinations. The determination unit 781 performs processing of the first determination of selecting the cell C to be transferred to the microplate 4 from the first image of the dish 2 supporting the cells C captured by the camera unit 5 (first image capturing). With reference to the selection criterion data stored in the storage unit 75, the determination unit 781 performs the first determination based on whether the feature amount of each cell C acquired by the image processing of the first image by the image processing unit 74 agrees with the selection criterion data.

Also, the determination unit 781 performs processing of the second determination of selecting the cell C to be used for subsequent work from the second image of the microplate 4 after the transfer work of the cell C, the second image being captured by the camera unit 5 (second image capturing). The second determination can rely on the operator's selection operation of the cell C received by the input unit 76. Alternatively, the selection criterion data for the second determination may be stored in the storage unit 75, and the determination unit 781 may make a determination automatically.

When the first determination and the second determination have different determination results about a certain cell C, the correction unit 782 performs processing of updating the selection criterion data stored in the storage unit 75 such that the first determination and the second determination about the cell C become identical in the subsequent determination. Specifically, the correction unit 782 reflects the feature amount of the cell C in which discrepancy has occurred in the selection criterion data. That is, when the cell C is determined as “not selected” in the second determination, the selection criterion data is updated to prevent the feature amount of the cell C from being included in the selection criterion data. On the other hand, when the cell C that is determined as “not selected” in the first determination is determined as “selected” in the second determination, conversely, the selection criterion data is updated such that the feature amount of the cell C is included in the selection criterion data.

By analyzing the image of the cell C specified by the image processing unit 74 in the first image or the second image described above, the analyzing unit 783 performs processing of extracting the feature amount of the cell C. Examples of the feature amount to be extracted include the shape, number, area, estimated volume, color, appearance, light intensity, or the like of the cell C. The analyzing unit 783 digitizes these feature amounts, and the determination unit 781 and the correction unit 782 perform predetermined processing by using this numerical value. For example, for the cell C selected or not selected in the second determination, the analyzing unit 783 extracts the feature amount of the cell C based on the image acquired in the second image capturing. The correction unit 782 updates the selection criterion data by using the numerical value of the extracted feature amount.

In a stage where determination is made that learning of the selection criterion data has progressed by the update processing of the correction unit 782, the determination unit 781 can execute an automatic determination mode in which the result of the first determination is used in the second determination. This is because, by repeating the update (learning) of the selection criterion data, the first determination and the second determination are gradually homogenized before long, and it becomes possible to select the truly necessary cell C only by the first determination.

[Flow of Cell Transfer Operation]

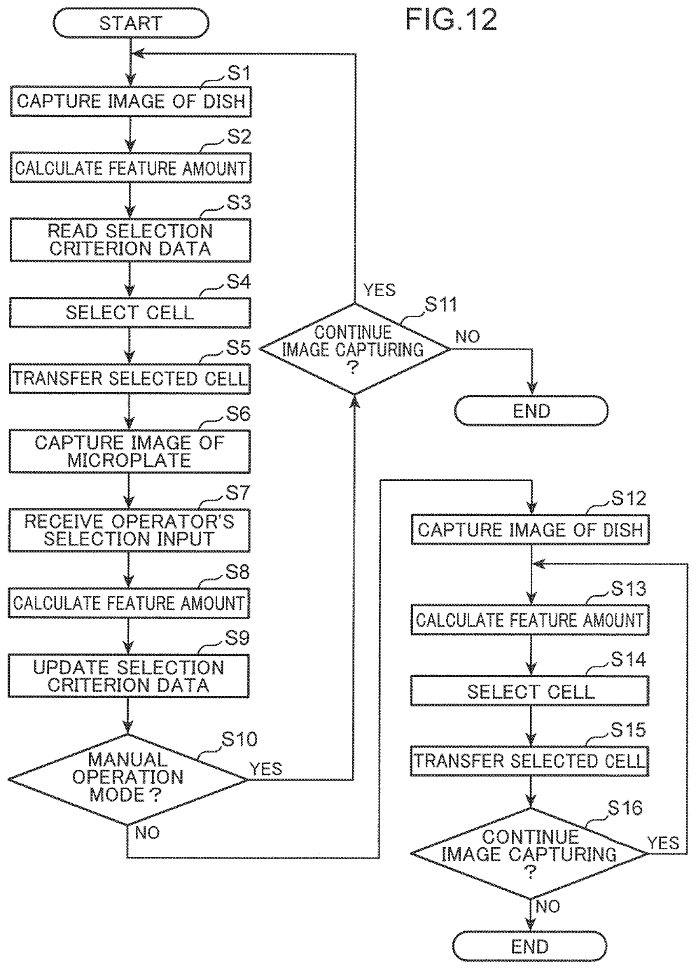

Subsequently, the cell transfer operation using the image capturing system of the present embodiment shown in FIG. 11 will be described with reference to the flowchart shown in FIG. 12. When the processing starts, the main control unit 78 causes the camera unit 5 to capture an image of the dish 2 (first image capturing). A cell suspension has been dispensed in the dish 2 in advance. The camera unit 5 captures an image of the cells C accommodated in the holding recesses 3 of the dish 2 (step S1).

Next, the image processing unit 74 performs image processing of acquiring image data of the dish 2 acquired by the image capturing from the camera body 52, and specifying the cells C included in the image. The image processing data is sent to the analyzing unit 783 of the main control unit 78. The analyzing unit 783 performs processing of determining the feature amount of the specified cell C such as the shape, number, area, estimated volume, color, appearance, light intensity, and the like of the cell C (step S2).

Subsequently, the determination unit 781 reads the selection criterion data of the cell C from the storage unit 75 (step S3), and with reference to the selection criterion data, the determination unit 781 performs the first determination of determining which of the cells C supported in the dish 2 is to be selected as the transfer target (step S4).

When the cell C to be transferred is determined, the main control unit 78 performs cell transfer work of transferring the cell C from the dish 2 serving as the first container to the microplate 4 serving as the second container (step S5). Specifically, the head control unit 72 controls the head drive unit 64 to cause the tip 12 attached to the head 61 to pick the cell C supported in the holding recess 3 of the dish 2. The axis control unit 71 controls the head unit axis drive unit 63 to move the head unit 6 to the position above the microplate 4. Furthermore, the head control unit 72 controls the head drive unit 64 to discharge the cell C sucked by the tip 12 into the predetermined well 41.

After discharge of the cell C into the well 41 is finished, the main control unit 78 causes the camera unit 5 to capture an image of the microplate 4 (second image capturing) (step S6). The image acquired by this image capturing is displayed on the display unit 77. The operator visually recognizes the display unit 77 and determines which cell C is to be selected from among the cells C transferred to respective wells 41 of the microplate 4 for subsequent work. The determination result is received by the input unit 76. The determination unit 781 treats instruction information input to the input unit 76 as the second determination of selecting the cell C after predetermined work (step S7).

If there is a cell C for which different determinations are made between the first determination of step S4 and the second determination of step S7, the feature amount of the cell C is calculated by the analyzing unit 783 (step S8). Then, the correction unit 782 updates the selection criterion data for the first determination stored in the storage unit 75 based on the feature amount extracted by the analyzing unit 783 (step S10). Note that when there is no discrepancy between the first determination and the second determination, steps S8 and S9 are skipped.

Subsequently, the main control unit 78 determines whether the operation mode set in the cell transfer device S is a manual operation mode (step S10). The manual operation mode is a mode of performing the image capturing in step S6 and the input reception in step S7 after the transfer work of the cell C, and is a mode performed in a stage where the selection criterion data of the storage unit 75 is not sufficiently learned.

When the operation mode is set as the manual operation mode (YES in step S10), the main control unit 78 confirms whether the next image capturing of the dish 2 (first image capturing) is scheduled (step S11). When the first image capturing is scheduled (YES in step S11), the main control unit 78 returns to step S1 to perform the next first image capturing. In the next routine, in step S4, the selection criterion data updated in step S9 is used.

On the other hand, when the automatic determination mode is set instead of the manual operation mode in step S10 (NO in step S10), the main control unit 78 performs the operation from which steps S6 to S9 described above are omitted. The automatic determination mode is a mode performed when reaching a stage where determination is made that the learning of the selection criterion data has progressed by the update processing of the correction unit 782, and is a mode in which the result of the first determination is treated as the result of the second determination.

In this case, the main control unit 78 causes the camera unit 5 to capture an image of the dish 2 supporting the cells C (first image capturing) (step S12), and the feature amount of the cells C in the acquired image is calculated by the analyzing unit 783 (step S13). Subsequently, the determination unit 781 makes the first determination of selecting the cell C to be transferred with reference to the selection criterion data stored in the storage unit 75 (step S14). Then, the main control unit 78 transfers the selected cell C from the dish 2 to the microplate 4 (step S15). As described above, since the second determination is omitted in the automatic determination mode, the work in the next stage, for example, addition of a reagent or the like is performed on all the transferred cells C.

Thereafter, it is confirmed whether to continue the image capturing of the cell C (step S16). When the image capturing is continued (YES in step S16), returning to step S13, the camera unit 5 performs the next image capturing operation on the dish 2. On the other hand, when there is no cell C to be captured (NO in step S16), the process ends.

With the image capturing system according to the present embodiment described above, regarding the selection of the cell C, in the image acquired by the first image capturing performed before the predetermined work on the cell C, the first determination selected by the determination unit 781 based on the selection criterion data is compared with the second determination based on the image acquired by the second image capturing acquired after the predetermined work is performed. Then, if there is a discrepancy between the two, the correction unit 782 updates the selection criterion data such that the first determination and the second determination become identical. Therefore, the selection criterion data is gradually corrected so as to agree with the second determination made after predetermined work. Therefore, it is possible to increase the probability of determining to be “selected” in the second determination, and increase the work efficiency of subsequent inspections and tests on the cell C.

[Configurations Included in the Above Embodiments]

Note that the above-described specific embodiments mainly include the disclosure having the following configurations.

An image capturing system according to one aspect of the present disclosure includes an image capturing device capable of performing first image capturing to capture an image of a biological subject before predetermined work is performed and second image capturing to capture the image of the biological subject after the work is performed; and a determination unit configured to make a first determination to determine whether to select the biological subject based on a predetermined selection criterion from the image acquired by the first image capturing, and a second determination to determine whether to select the biological subject from the image acquired by the second image capturing. The image capturing system further includes a storage unit configured to store data regarding the selection criterion; and a correction unit configured to update the data stored in the storage unit to make the first determination and the second determination about the biological subject come close to each other in a subsequent determination when the first determination and the second determination have different determination results.

With the image capturing system, regarding the selection of the biological subject, the first determination made based on the predetermined selection criterion in the image acquired by the first image capturing is compared with the second determination based on the image acquired by the second image capturing acquired after the predetermined work is performed. Then, if there is a discrepancy between the two, the data regarding the selection criterion is updated to make the first determination and the second determination identical to each other. Therefore, the data of the selection criterion is gradually corrected so as to agree with the second determination made after predetermined work. Therefore, it is possible to increase the probability of determining to be “selected” in the second determination, and it is possible to increase the work efficiency of the subsequent inspection or test on the biological subject.

Preferably, the image capturing system further includes an input unit configured to receive input from an operator regarding a selection operation on the biological subject, in which the predetermined work is the selection operation received by the input unit, the selection operation also serving as the second determination.

With the image capturing system, the data of the selection criterion on which the first determination relies is updated so as to follow the selection operation result of the operator which also serves as the second determination. That is, the result of the operator's selection operation is fed hack to the first determination. Therefore, the result of the first determination gradually follows the tendency of the operator's selection operation, and the second determination ((selection operation) can be simplified.

In the image capturing system, preferably, the predetermined work is work of transferring the biological subject selected as a transfer target from a first container accommodating a plurality of the biological subjects to a second container, the first image capturing is image capturing of the biological subjects accommodated in the first container, and the second image capturing is image capturing of the biological subject transferred to the second container.

With this image capturing system, the result of the second determination based on the image of the second image capturing, which is performed after the work of transfer of the biological subject from the first container to the second container, is fed back to the first determination. Therefore, the selection of the biological subject is performed before the transfer work to follow the selection result of the biological subject after the transfer work.

In this case, preferably, the image capturing system further includes an analyzing unit configured to extract, regarding the biological subject selected or the biological subject not selected in the second determination, a feature amount of the biological subject based on the image captured by the second image capturing, in which the correction unit updates the data regarding the selection criterion based on the feature amount extracted by the analyzing unit.

With this image capturing system, it is possible to objectively evaluate the result of the second determination based on the feature amount and feed this back to the selection criterion data.

Furthermore, in the image capturing system, preferably, the second container includes a plurality of wells that accommodate the biological subjects, and the feature amount includes information on a number of the biological subjects accommodated in each of the wells. With this configuration, the information on the number of biological subjects can be reflected on the selection criterion data.

In the image capturing system, preferably, the predetermined work is work of changing an image capturing condition in the first image capturing, and the second image capturing is performed under the changed image capturing condition.

With this image capturing system, the second determination is made based on the image acquired after the image capturing condition is changed, that is, based on the image acquired by changing the viewpoint of the biological subject. Then, the result of this second determination is fed back to the first determination. Therefore, the selection of the biological subject is performed in the first determination to follow the selection result of the biological subject with the changed viewpoint.

In the image capturing system, preferably, the predetermined work is work of adding a reactive test substance to the biological subject.

With this image capturing system, the result of the second determination based on the image of the second image capturing, which is performed after the work of adding the reactive test substance to the biological subject, is fed back to the first determination. Therefore, the selection of the biological subject is performed before the addition work to follow the selection result of the biological subject after the addition work of the reactive test substance.

In the image capturing system, preferably, the predetermined work is work of waiting for an elapse of a predetermined test time after the first image capturing.

With this image capturing system, the result of the second determination based on the image of the second image capturing, which is performed after the work of waiting for an elapse of a predetermined test time, is fed back to the first determination. Therefore, the selection of the biological subject is performed in the first determination to follow the selection result of the biological subject after the elapse of the test time.

In the image capturing system, preferably, the predetermined work further includes work of transferring the biological subject selected as a transfer target from a first container accommodating a plurality of the biological subjects to a second container, the first image capturing is image capturing of the biological subjects accommodated in the first container, the second image capturing is image capturing of the biological subject transferred to the second container, and the work of adding a reactive test substance or the work of waiting for an elapse of a test time is performed on the biological subject after being transferred to the second container.

In the image capturing system, preferably, in a stage in which determination is made that learning of the data regarding the selection criterion has progressed due to the update by the correction unit, the determination unit has an automatic determination mode in which a result of the first determination is used in the second determination.

With this image capturing system, if it is determined that the learning has progressed due to the progress of feedback to the first determination, the second determination is omitted. Therefore, work efficiency can be further enhanced.

A biological subject transfer device according to another aspect of the present disclosure includes the above-described image capturing system; and a head device configured to perform transfer work of picking the biological subject selected as the transfer target from the first container accommodating the plurality of biological subjects and transferring the biological subject to the second container as the predetermined work.

The present disclosure can provide the image capturing system that can accurately select the biological subject required by the operator, and the biological subject transfer device using the image capturing system.

What is claimed is:

1. An image capturing system comprising:
an image capturing device configured to perform first image capturing to capture an image of a biological subject before predetermined work is performed and second image capturing to capture the image of the biological subject after the work is performed;
a determination unit configured to make a first determination to determine whether to select the biological subject based on a predetermined selection criterion from the image acquired by the first image capturing, and a second determination to determine whether to select the biological subject from the image acquired by the second image capturing;
a storage unit configured to store data regarding the selection criterion; and
a correction unit configured to update the data stored in the storage unit to make the first determination and the second determination about the biological subject come close to each other in a subsequent determination when the first determination and the second determination have different determination results.

2. The image capturing system according to claim 1, further comprising an input unit configured to receive input from an operator regarding a selection operation on the biological subject,
wherein the predetermined work is the selection operation received by the input unit, the selection operation also serving as the second determination.

3. The image capturing system according to claim 1, wherein
the predetermined work is work of transferring the biological subject selected as a transfer target from a first container accommodating a plurality of the biological subjects to a second container,
the first image capturing is image capturing of the biological subjects accommodated in the first container, and
the second image capturing is image capturing of the biological subject transferred to the second container.

4. The image capturing system according to claim 3,
further comprising an analyzing unit configured to extract, regarding the biological subject selected or the biological subject not selected in the second determination, a feature amount of the biological subject based on the image captured by the second image capturing,
wherein the correction unit is configured to update the data regarding the selection criterion based on the feature amount extracted by the analyzing unit.

5. The image capturing system according to claim 4, wherein
the second container includes a plurality of wells that accommodate the biological subjects, and
the feature amount includes information on a number of the biological subjects accommodated in each of the wells.

6. The image capturing system according to claim 1, wherein
the predetermined work is work of changing an image capturing condition in the first image capturing, and
the second image capturing is performed under the changed image capturing condition.

7. The image capturing system according to claim 1,
wherein the predetermined work is work of adding a reactive test substance to the biological subject.

8. The image capturing system according to claim 1, wherein the predetermined work is work of waiting for an elapse of a predetermined test time after the first image capturing.

9. The image capturing system according to claim 7, wherein
the predetermined work further includes work of transferring the biological subject selected as a transfer target from a first container accommodating a plurality of the biological subjects to a second container,
the first image capturing is image capturing of the biological subjects accommodated in the first container,
the second image capturing is image capturing of the biological subject transferred to the second container, and
the work of adding a reactive test substance or the work of waiting for an elapse of a test time is performed on the biological subject after being transferred to the second container.

10. The image capturing system according to claim 1, wherein in a stage in which determination is made that learning of the data regarding the selection criterion has progressed due to the update by the correction unit, the determination unit has an automatic determination mode in which a result of the first determination is used in the second determination.

11. A biological subject transfer device comprising:
the image capturing system according to claim 1; and
a head device configured to perform transfer work of picking the biological subject selected as the transfer target from the first container accommodating the plurality of biological subjects and transferring the biological subject to the second container as the predetermined work.

12. The image capturing system according to claim 2, wherein
the predetermined work is work of transferring the biological subject selected as a transfer target from a first container accommodating a plurality of the biological subjects to a second container,
the first image capturing is image capturing of the biological subjects accommodated in the first container, and
the second image capturing is image capturing of the biological subject transferred to the second container.

13. The image capturing system according to claim 2, wherein
the predetermined work is work of changing an image capturing condition in the first image capturing, and
the second image capturing is performed under the changed image capturing condition.

14. The image capturing system according to claim 2, wherein the predetermined work is work of adding a reactive test substance to the biological subject.

15. The image capturing system according to claim 2, wherein the predetermined work is work of waiting for an elapse of a predetermined test time after the first image capturing.

16. The image capturing system according to claim 8, wherein
the predetermined work further includes work of transferring the biological subject selected as a transfer target from a first container accommodating a plurality of the biological subjects to a second container,
the first image capturing is image capturing of the biological subjects accommodated in the first container,
the second image capturing is image capturing of the biological subject transferred to the second container, and
the work of adding a reactive test substance or the work of waiting for an elapse of a test time is performed on the biological subject after being transferred to the second container.

17. The image capturing system according to claim 12, further comprising an analyzing unit configured to extract, regarding the biological subject selected or the biological subject not selected in the second determination, a feature amount of the biological subject based on the image captured by the second image capturing,
wherein the correction unit updates the data regarding the selection criterion based on the feature amount extracted by the analyzing unit.

18. The image capturing system according to claim 17, wherein
the second container includes a plurality of wells that accommodate the biological subjects, and
the feature amount includes information on a number of the biological subjects accommodated in each of the wells.

19. A biological subject transfer device comprising:
the image capturing system according to claim 3; and
a head device configured to perform transfer work of picking the biological subject selected as the transfer target from the first container accommodating the plurality of biological subjects and transferring the biological subject to the second container as the predetermined work.

20. A biological subject transfer device comprising:
the image capturing system according to claim 4; and
a head device configured to perform transfer work of picking the biological subject selected as the transfer target from the first container accommodating the plurality of biological subjects and transferring the biological subject to the second container as the predetermined work.
